(19) United States
(12) Patent Application Publication
(10) Pub. No.: US 2023/0336344 A1
(43) Pub. Date: Oct. 19, 2023

(54) DATA PROCESSING METHODS, APPARATUSES, AND COMPUTER DEVICES FOR PRIVACY PROTECTION

(71) Applicant: Alipay (Hangzhou) Information Technology Co., Ltd., Hangzhou (CN)

(72) Inventors: Yufei Lu, Hangzhou (CN); Pu Duan, Hangzhou (CN); Lei Wang, Hangzhou (CN); Chaofan Yu, Hangzhou (CN)

(73) Assignee: Alipay (Hangzhou) Information Technology Co., Ltd., Hangzhou (CN)

(21) Appl. No.: 18/299,471

(22) Filed: Apr. 12, 2023

(30) Foreign Application Priority Data
Apr. 15, 2022 (CN) 202210394145.9

(51) Int. Cl. H04L 9/30; H04L 9/08

(52) U.S. Cl. CPC H04L 9/3026; H04L 9/0869; H04L 9/085; H04L 2209/46

(57) ABSTRACT

Implementations disclose data processing methods, apparatuses, and computer devices for privacy protection in secure multi-party computation, including encoding private data to a coefficient of a first polynomial function. A plurality of function values of the first polynomial function are obtained as a plurality of fragments obtained after the private data is split, where the fragments of the private data are used for computation by using a secret sharing algorithm to obtain fragments of target data.

### CROSS-REFERENCE TO RELATED APPLICATIONS

This application claims priority to Chinese Patent Application No. 202210394145.9, filed on Apr. 15, 2022, which is hereby incorporated by reference in its entirety.

### TECHNICAL FIELD

Embodiments of this specification relate to the field of computer technologies, and in particular, to data processing methods, apparatuses, and computer devices for privacy protection.

### BACKGROUND

In some scenarios, data of different data parties usually needs to be jointly analyzed. In a process of jointly analyzing data of a plurality of parities, protection and security of data privacy has become a concern.

For example, one institution has a limited amount of data. Therefore, in many scenarios, data of a plurality of institutions needs to be jointly analyzed. However, the data of the institution possibly involve data such as user privacy or service information that needs to be kept secret. Therefore, in a process of jointly analyzing the data of the plurality of institutions, security of private data of the institutions needs to be protected.

### SUMMARY

Embodiments of this specification provide data processing methods, apparatuses, and computer devices for privacy protection to implement collaborative data processing without leakage of data privacy. The technical solutions in the embodiments of this specification are as follows.

According to a first aspect of the embodiments of this specification, a data processing method for privacy protection is provided, which is applied to the field of secure multi-party computation and includes the following: private data is encoded to a coefficient of a first polynomial function; and a plurality of function values of the first polynomial function are obtained as a plurality of fragments obtained after the private data is split, where the fragments of the private data are used for computation by using a secret sharing algorithm to obtain fragments of target data.

According to a second aspect of the embodiments of this specification, a data processing method for privacy protection is provided, which is applied to the field of secure multi-party computation and includes the following: fragments of a plurality of pieces of private data are obtained, where the fragments of the private data include function values of a first polynomial function, and the private data is encoded to a coefficient of the first polynomial function; and the fragments of the plurality of pieces of private data are computed by using a secret sharing algorithm to obtain fragments of target data.

According to a third aspect of the embodiments of this specification, a data processing method for privacy protection is provided, which is applied to the field of secure multi-party computation and includes the following: a plurality of fragments of target data are obtained, where the fragments of the target data are computed based on fragments of private data, the fragments of the private data include function values of a first polynomial function, and the private data is encoded to a coefficient of the first polynomial function; a coefficient of a second polynomial function is computed by using the plurality of fragments of the target data as a plurality of function values of the second polynomial function and based on the plurality of function values of the second polynomial function, where the target data is encoded to the coefficient of the second polynomial function; and the target data is recovered based on the coefficient of the second polynomial function.

According to a fourth aspect of the embodiments of this specification, a data processing apparatus for privacy protection is provided, which is applied to the field of secure multi-party computation and includes the following: an encoding unit, configured to encode private data to a coefficient of a first polynomial function; and an acquisition unit, configured to obtain a plurality of function values of the first polynomial function as a plurality of fragments obtained after the private data is split, where the fragments of the private data are used for computation by using a secret sharing algorithm to obtain fragments of target data.

According to a fifth aspect of the embodiments of this specification, a data processing apparatus for privacy protection is provided, which is applied to the field of secure multi-party computation and includes the following: an acquisition unit, configured to obtain fragments of a plurality of pieces of private data, where the fragments of the private data include function values of a first polynomial function, and the private data is encoded to a coefficient of the first polynomial function; and a computation unit, configured to compute the fragments of the plurality of pieces of private data by using a secret sharing algorithm to obtain fragments of target data.

According to a sixth aspect of the embodiments of this specification, a data processing apparatus for privacy protection is provided, which is applied to the field of secure multi-party computation and includes the following: an acquisition unit, configured to obtain a plurality of fragments of target data, where the fragments of the target data are computed based on fragments of private data, the fragments of the private data include function values of a first polynomial function, and the private data is encoded to a coefficient of the first polynomial function; a computation unit, configured to compute a coefficient of a second polynomial function by using the plurality of fragments of the target data as a plurality of function values of the second polynomial function and based on the plurality of function values of the second polynomial function, where the target data is encoded to the coefficient of the second polynomial function; and a recovery unit, configured to recover the target data based on the coefficient of the second polynomial function.

According to a seventh aspect of the embodiments of this specification, a computer device is provided, including the following: at least one processor; and a memory storing program instructions, where the program instructions are configured to be applicable to be executed by the at least one processor, and the program instructions include instructions used for performing the methods according to the first aspect, the second aspect, or the third aspect.

According to the technical solutions provided in the embodiments of this specification, the private data is split by using the first polynomial function. In addition, the fragments of the plurality of pieces of private data can be further computed locally to obtain the fragments of the target data, and there is no need for a third party, thereby improving computing efficiency of the secret sharing algorithm. Moreover, the target data is further recovered by using the second polynomial function.

### BRIEF DESCRIPTION OF DRAWINGS

To describe the technical solutions in the embodiments of this specification or in the existing technology more clearly, the following briefly describes the accompanying drawings needed for describing the embodiments or the existing technology. The accompanying drawings in the following description show merely some embodiments recorded in this specification, and a person of ordinary skill in the art can still derive other accompanying drawings from these accompanying drawings without creative efforts.

FIG. 1 is a schematic diagram illustrating an operation process of a secret sharing addition algorithm in a related technology;

FIG. 2 is a schematic diagram illustrating an operation process of a secret sharing multiplication algorithm in a related technology;

FIG. 3 is a schematic diagram illustrating a structure of a data processing system for privacy protection, according to one or more embodiments of this specification;

FIG. 4 is a schematic flowchart illustrating a data processing method for privacy protection, according to one or more embodiments of this specification;

FIG. 5 is a schematic flowchart illustrating a data processing method for privacy protection, according to one or more embodiments of this specification;

FIG. 6 is a schematic flowchart illustrating a data processing method for privacy protection, according to one or more embodiments of this specification;

FIG. 7 is a schematic diagram illustrating a structure of a data processing apparatus for privacy protection, according to one or more embodiments of this specification;

FIG. 8 is a schematic diagram illustrating a structure of a data processing apparatus for privacy protection, according to one or more embodiments of this specification;

FIG. 9 is a schematic diagram illustrating a structure of a data processing apparatus for privacy protection, according to one or more embodiments of this specification; and

FIG. 10 is a schematic diagram illustrating a structure of a computer device, according to one or more embodiments of this specification.

### DESCRIPTION OF EMBODIMENTS

The following clearly and comprehensively describes the technical solutions in the embodiments of this specification with reference to the accompanying drawings in the embodiments of this specification. Clearly, the described embodiments are merely some rather than all of the embodiments of this specification. All other embodiments obtained by a person of ordinary skill in the art based on the embodiments of this specification without creative efforts shall fall within the protection scope of this specification.

To facilitate understanding of the technical solutions in the embodiments of this specification, the following describes a polynomial function.

The polynomial function can be obtained by performing an addition operation, a multiplication operation, and an exponentiation operation a limited quantity of times. The polynomial function can include one or more monomials (referred to as terms below for short). Coefficients of the polynomial function can include coefficients of terms in the polynomial function. A coefficient of a constant term can be understood as the constant term itself. A degree of the polynomial function can be a degree of the highest-order term. For example, the polynomial function can be expressed as f(x)=aₙxⁿ+aₙ₋₁xⁿ⁻¹+ . . . +a₂x²+a₁x+a₀. The coefficients of the polynomial function can include aₙ, aₙ₋₁, a₂, a₁, a₀, etc., and the degree of the polynomial function can be n.

The polynomial function can include a coefficient representation method and a point representation method. In the coefficient representation method, the polynomial function can be represented based on the coefficients of the polynomial function. For example, the polynomial function f(x)=aₙxⁿ+aₙ₋₁xⁿ⁻¹+ . . . +a₂x²+a₁x+a₀ can be determined based on the coefficients {aₙ, aₙ₋₁, . . . , a₂, a₁, a₀} of the polynomial function. In the point representation method, the polynomial function can be represented based on sampling points of the polynomial function, and the sampling points include an independent variable value and a function value that are matched. For example, the polynomial function f(x)=aₙxⁿ+aₙ₋₁xⁿ⁻¹+ . . . +a₂x²+a₁x+a₀ can be determined based on sampling points {(x₀, y₀), (x₁, y₁), (x₂, y₂), . . . , (xₙ₋₁, yₙ₋₁), (xₙ, yₙ)}. The point representation method and the coefficient representation method of the polynomial function are equivalent. In the point representation method, if the degree of the polynomial function is n, at least (n+1) sampling points are needed to determine the polynomial function.

Secure multi-party computation (MPC) is an algorithm for protecting data privacy and security. Secure multi-party computation enables a plurality of participant parties holding private data to perform collaborative computing without leakage of data privacy. Secret sharing is a technology used for implementing secure multi-party computation. The idea of secret sharing is to split a secret in a proper method to obtain a plurality of fragments. The plurality of fragments are respectively kept by different participant parties. A single participant party cannot recover the secret, and the secret can be recovered only through collaboration of several participant parties. For example, in a (t, n)-threshold secret sharing scheme, a secret is split in a proper method to obtain n fragments. The n fragments are kept by n participant parties. A single participant party cannot recover the secret, and the secret can be recovered only through collaboration of at least t participant parties. If there are less than t participant parties, the secret cannot be recovered, where t can be understood as a threshold of the secret sharing scheme.

In a related technology, a secret sharing algorithm can include a secret sharing addition algorithm and a secret sharing multiplication algorithm. The secret sharing addition algorithm and the secret sharing multiplication algorithm are respectively described below by using two participant parties Alice and Bob as examples.

Alice holds secret A and Bob holds secret B. Alice can split secret A to obtain fragments a1 and a2, fragment a1 can be kept by Alice, and fragment a2 can be kept by Bob, where a1+a2=A. Bob can split secret B to obtain fragments b1 and b2, fragment b1 can be kept by Alice, and fragment b2 can be kept by Bob, where b1+b2=B.

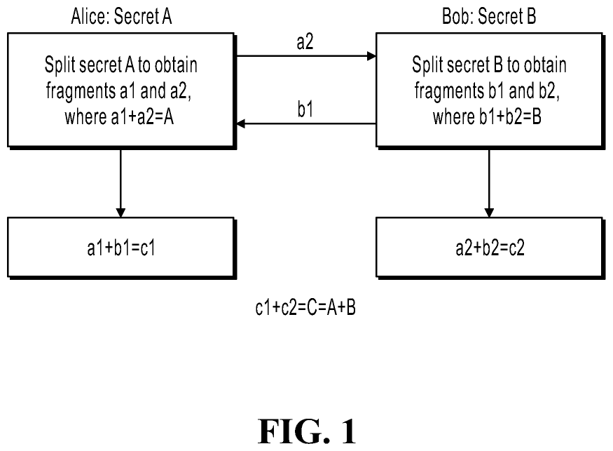

Referring to FIG. 1, in the secret sharing addition algorithm, Alice can add fragment a1 and fragment b1 to obtain fragment c1, and Bob can add fragment a2 and fragment b2 to obtain fragment c2. Both c1 and c2 are fragments of secret C, where c1+c2=C=A+B.

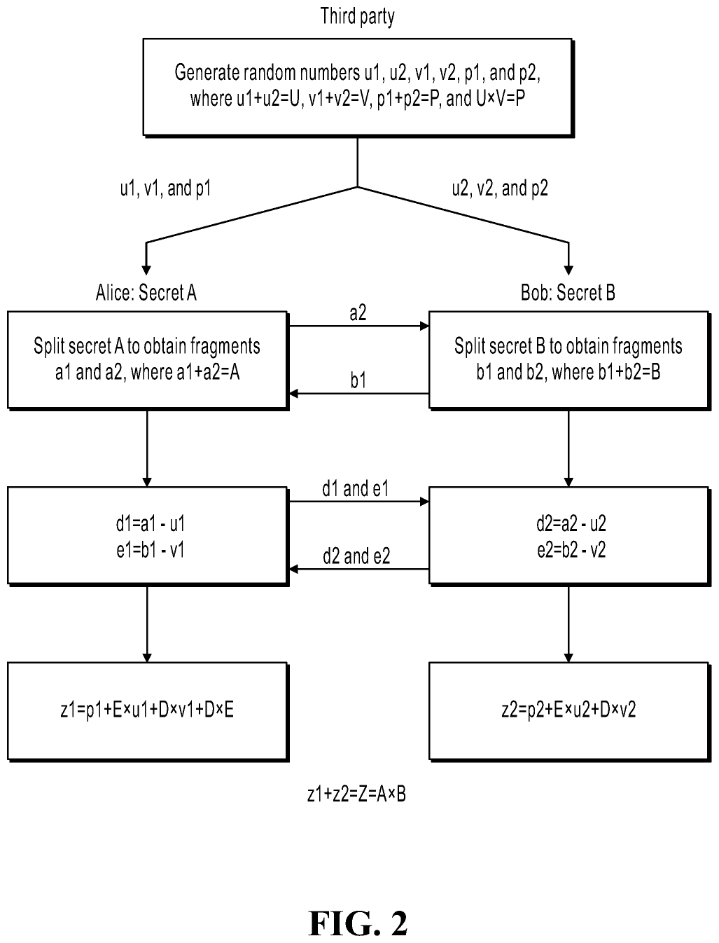

Referring to FIG. 2, in the secret sharing multiplication algorithm, a trusted third party (TTP) is needed. Alice and Bob need to separately communicate with the third party. Specifically, the third party can generate auxiliary data (triple). The auxiliary data can include random numbers u1, u2, v1, v2, p1, and p2. The random numbers in the auxiliary data satisfy specific conditions: u1+u2=U, v1+v2=V, p1+p2=P, and U×V=P. The third party can send random numbers u1, v1, and p1 to Alice, and can send random numbers u2, v2, and p2 to Bob. Alice can compute d1=a1−u1 and e1=b1−v1, and can send d1 and e1 to Bob. Bob can compute d2=a2−u2 and e2=b2−v2, and can send d2 and e2 to Alice. Alice can compute z1=p1+E×u1+D×v1+D×E, and Bob can compute z2=p2+E×u2+D×v2. Both z1 and z2 are fragments of secret Z, where z1+z2=Z=A×B, and D=d1+d2, E=e1+e2.

In the previous secret sharing algorithm, the secret is split in a form of an addition. For example, the two fragments a1 and a2 obtained after secret A is split satisfy a1+a2=A, and the two fragments b1 and b2 obtained after secret B is split satisfy b1+b2=B. Therefore, in the secret sharing multiplication algorithm, the auxiliary data (triple) generated by the third party is needed, and the participant parties of the secret sharing algorithm need to communicate with the third party, which reduces computing efficiency of the secret sharing algorithm. In addition, the auxiliary data generated by the third party also needs to satisfy specific conditions. For example, the random numbers u1, u2, v1, v2, p1, and p2 generated by the third party need to satisfy the following specific conditions: u1+u2=U, v1+v2=V, p1+p2=P, U×V=P. When a quantity of participant parties in the secret sharing algorithm is relatively small (for example, two or three), it is relatively easy to generate auxiliary data satisfying the specific conditions. However, when the quantity of participant parties in the secret sharing algorithm is relatively large (for example, four or more), it is difficult to generate auxiliary data satisfying the specific conditions. Therefore, the secret sharing algorithm described above is applicable only to a relatively small quantity of participant parties, and is difficult to be applicable to a relatively large quantity of participant parties.

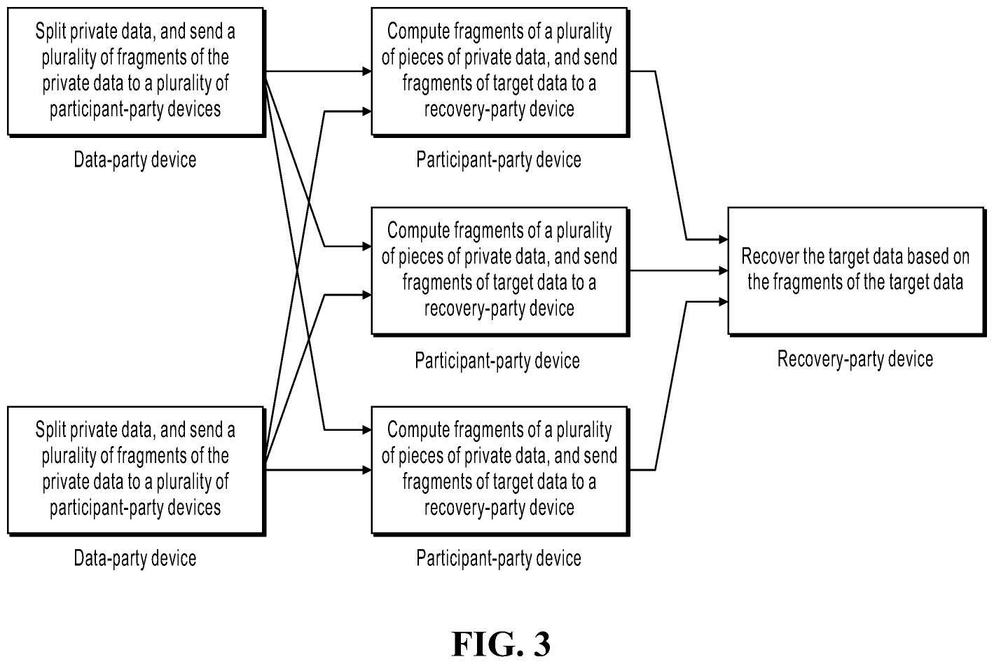

Referring to FIG. 3, one or more embodiments of this specification provide a data processing system for privacy protection. The data processing system can include a plurality of data-party devices, a plurality of participant-party devices, and at least one recovery-party device. The data-party device, the participant-party device, and the recovery-party device can be computer devices having a data processing capability. The computer device can be a personal computer, a laptop computer, a cellular phone, a smart phone, a personal digital assistant, a media player, a navigation device, a game console, a tablet computer, a wearable device, a server, or a combination of any of these devices.

The data-party device, the participant-party device, and the recovery-party device can be different computer devices; or more of the data-party device, the participant-party device, and the recovery-party device can be integrated as one computer device. For example, the data-party device and the participant-party device can be integrated as one computer device, or the participant-party device and the recovery-party device can be integrated as one computer device, or the data-party device and the recovery-party device can be integrated as one computer device.

The data-party device can be set up by a data party, the participant-party device can be set up by a participant party, and the recovery-party device can be set up by a recovery party. The data party, the participant party, and the recovery party can be different institutions, or more of the data party, the participant party, and the recovery party can be the same institution. The institution can include a financial institution, a government institution, a big data company, an e-commerce company, a cloud computing vendor for providing a computing service, etc.

In some embodiments, the data-party device can hold private data. For security of the private data, the data-party device cannot send the private data in plaintext. The data-party device can split the private data. Specifically, the data-party device can encode the private data to a coefficient of a polynomial function (referred to as a first polynomial function below), can obtain a plurality of function values of the first polynomial function as a plurality of fragments obtained after the private data is split, and can send the plurality of fragments of the private data to the plurality of participant-party devices. As such, the private data is split by using the first polynomial function.

The plurality of data-party devices hold a plurality of pieces of different private data. Different data-party devices can encode the private data to coefficients of different first polynomial functions. Degrees of the different first polynomial functions can be the same or different.

In some embodiments, the participant-party device is configured to perform cryptographic computing on a plurality of pieces of private data. Specifically, the participant-party device can obtain fragments of the plurality of pieces of private data, and can compute the fragments of the plurality of pieces of private data by using a secret sharing algorithm to obtain fragments of target data. Therefore, the participant-party device can compute the fragments of the plurality of pieces of private data locally without a need for a third party, thereby improving computing efficiency of the secret sharing algorithm. Moreover, the computation process does not need to rely on auxiliary data satisfying specific conditions, and is applicable to secure multi-party computation that has a relatively large quantity of participant-party devices.

In some embodiments, the recovery-party device is configured to recover target data based on fragments of the target data. Specifically, the recovery-party device can obtain a plurality of fragments of the target data; can use the plurality of fragments of the target data as a plurality of function values of a polynomial function (referred to as a second polynomial function below); can compute a coefficient of the second polynomial function based on the plurality of function values of the second polynomial function, where the target data is encoded to the coefficient of the second polynomial function; and can recover the target data based on the coefficient of the second polynomial function. As such, the target data is recovered by using the second polynomial function.

One or more embodiments of this specification provide a data processing method for privacy protection. The method can be applied to the field of secure multi-party computation. The method can be performed by any of the plurality of data-party devices.

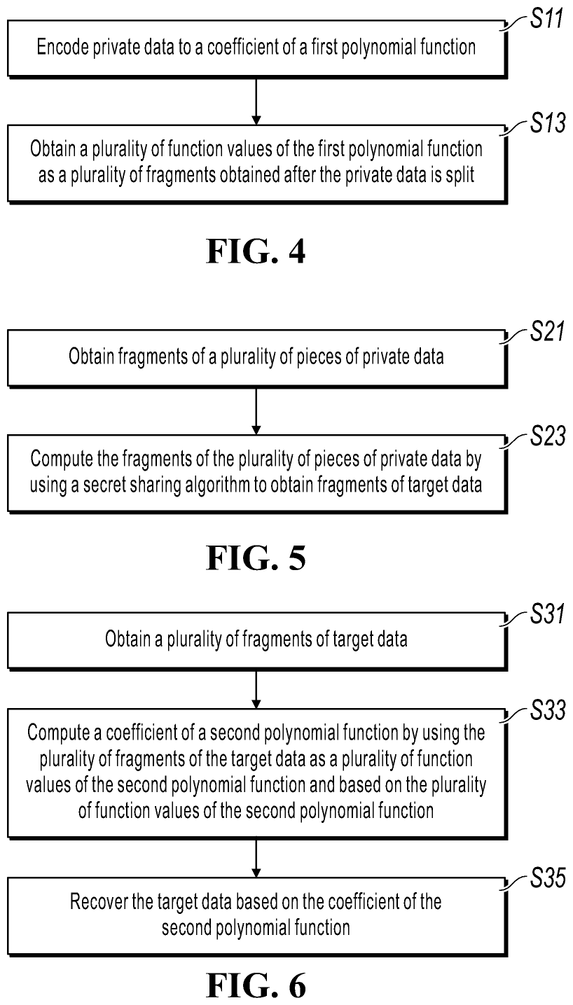

Referring to FIG. 4, the method can include the following steps.

Step S11: Encode private data to a coefficient of a first polynomial function.

In some embodiments, the private data includes service data used for performing secure multi-party computation. For example, the private data can include user data, commodity data, transaction data, behavior data, etc. The user data includes age, gender, occupation, etc. The commodity data includes a commodity category, evaluation data, etc. The transaction data includes a transaction amount, a transaction method, etc. The behavior data includes transaction behavior data, payment behavior data, purchase behavior data, etc. For another example, the private data can further include text data, image data, audio data, etc.

In some embodiments, a degree of the first polynomial function can be set based on at least one of the following.

### (1) Quantity of Participant-Party Devices

Fragments of private data can be understood as function values of sample points in a point representation method. In the point representation method, if a degree of a polynomial function is n, at least (n+1) sampling points are needed to determine the polynomial function. Therefore, to recover the private data based on the fragments of the private data, the degree of the first polynomial function can be smaller than a quantity of fragments of the private data. In addition, considering that each participant-party device can keep one fragment of the private data, the quantity of fragments of the private data can be equal to a quantity of participant-party devices. Therefore, the degree of the first polynomial function can be smaller than the quantity of participant-party devices.

### (2) Quantity of Times of Performing a Secret Sharing Multiplication Algorithm

Fragments of target data can be understood as function values of sampling points in a point representation method. In the point representation method, if a degree of a polynomial function is n, at least (n+1) sampling points are needed to determine the polynomial function. Therefore, to recover the target data based on the fragments of the target data, a degree of a second polynomial function can be smaller than a quantity of fragments of the target data. In addition, considering that each participant-party device can keep one fragment of the target data, the quantity of fragments of the target data can be equal to a quantity of participant-party devices. Therefore, the degree of the second polynomial function can be smaller than the quantity of participant-party devices.

Because the fragments of the target data are computed based on the fragments of the private data, the degree of the second polynomial function is greater than or equal to the degree of the first polynomial function. For example, the fragments of the target data can be computed from the fragments of the private data by using a secret sharing addition algorithm. In this case, the degree of the second polynomial function can be equal to the degree of the first polynomial function. For another example, the fragments of the target data can alternatively be computed from the fragments of the private data by using the secret sharing multiplication algorithm. In this case, the degree of the second polynomial function can be greater than the degree of the first polynomial function. In addition, based on the degree of the first polynomial function, the degree of the second polynomial function increases accordingly as a quantity of times of performing the secret sharing multiplication algorithm increases.

Therefore, considering the previous factors, the degree of the first polynomial function is further inversely correlated to the quantity of times of performing the secret sharing multiplication algorithm. A larger quantity of times of performing the secret sharing multiplication algorithm indicates a smaller degree of the first polynomial function, and a smaller quantity of times of performing the secret sharing multiplication algorithm indicates a larger degree of the first polynomial function.

### (3) Threshold of the Secret Sharing Algorithm

The degree of the first polynomial function is further positively correlated to the threshold of the secret sharing algorithm. A larger degree of the first polynomial function indicates a larger threshold of the secret sharing algorithm and a larger quantity of fragments needed to recover the target data, and a smaller degree of the first polynomial function indicates a smaller threshold of the secret sharing algorithm and a larger quantity of fragments needed to recover the target data.

For example, a quantity of participant-party devices is 3, and a quantity of times of performing the secret sharing multiplication algorithm is 1. The degree of the first polynomial function can be set to 1, and the first polynomial function can be expressed as f(x)=a₁x+a₀. Therefore, the participant-party device can perform the secret sharing addition algorithm a plurality of times and/or perform the secret sharing multiplication algorithm once on the fragments of the private data. For another example, considering that the secret sharing multiplication algorithm is performed a smaller quantity of times than the secret sharing addition algorithm, if a quantity of participant-party devices is p, the degree of the first polynomial function can be n=[p/2], where [p/2] represents a maximum integer not exceeding p/2.

In some embodiments, a coefficient of one or more terms in the first polynomial functions can be the private data.

A constant term in the first polynomial function can be the private data. Specifically, the private data can be determined as the constant term in the first polynomial function, and a random number can be generated as a coefficient of a term other than the constant term in the first polynomial function. For example, the degree of the first polynomial function can ben. The private data can be determined as the constant term in the first polynomial function, and m random numbers can be generated as coefficients of (n−1) terms other than the constant term in the first polynomial function, where m≤n−1. For another example, the private data can be determined as the constant term in the first polynomial function and a coefficient of at least one term other than the constant term, and a random number can be generated as a coefficient of the remaining term in the first polynomial function.

Alternatively, a coefficient of at least one term other than the constant term in the first polynomial function can be the private data. Specifically, the private data can be determined as the coefficient of the at least one term other than the constant term in the first polynomial function, and the random number can be generated as a coefficient of the remaining term in the first polynomial function. For example, the private data can be determined as a coefficient of a linear term in the first polynomial function, and a random number can be generated as a coefficient of a term other than the linear term in the first polynomial function.

Step S13: Obtain a plurality of function values of the first polynomial function as a plurality of fragments obtained after the private data is split.

In some embodiments, the participant-party device corresponds to a value, and values corresponding to different participant-party devices can be the same or different. For example, a quantity of participant-party devices is 4, and values corresponding to the four participant-party devices include 1, 2, 5, and 7. A plurality of values corresponding to a plurality of participant-party devices can be obtained as a plurality of values of an independent variable in the first polynomial function, and the plurality of function values of the first polynomial function can be computed based on the plurality of values of the independent variable and used as the plurality of fragments obtained after the private data is split.

The value corresponding to the participant-party device can be a random number, or the value corresponding to the participant-party device can be a value satisfying a certain condition, for example, a value satisfying a mathematical distribution such as a normal distribution. In actual applications, the value corresponding to the participant-party device can be obtained through negotiation between the data-party device and the participant-party device. The data-party device can obtain the negotiated value. Alternatively, the value corresponding to the participant-party device can alternatively be generated by the participant-party device. The participant-party device can send the generated value to the data-party device, and the data-party device can receive the value sent from the participant-party device. Certainly, the value corresponding to the participant-party device can alternatively be generated by the data-party device or another computer device. Implementations are not limited in the one or more embodiments of this specification.

In some embodiments, the fragments of the private data are used for computation by using the secret sharing algorithm to obtain the fragments of the target data. Specifically, the plurality of fragments of the private data can be sent to a plurality of participant-party devices. Therefore, the participant-party device performs computation based on the received fragment of the private data by using the secret sharing algorithm to obtain the fragments of the target data. In actual applications, for each participant-party device, a target fragment can be selected from the plurality of fragments of the private data based on a value corresponding to the participant party and sent to the participant-party device. The target fragment is a target function value of the first polynomial function. The target function value matches the value corresponding to the participant-party device (that is, the value of the independent variable).

According to the data processing method in the one or more embodiments of this specification, the private data can be encoded to the coefficient of the first polynomial function, the plurality of function values of the first polynomial function can be obtained as the plurality of fragments obtained after the private data is split, and the fragments of the private data are used for computation by using the secret sharing algorithm. As such, the private data is split by using the first polynomial function.

In some scenario examples, the data-party device can hold private data A. A value corresponding to participant-party device P1 can be x1, a value corresponding to participant-party device P2 can be x2, and a value corresponding to participant-party device P3 can be x3.

In this scenario example, the first polynomial function can be expressed as y=ax+b. The data-party device can determine private data A as a constant term in the first polynomial function, and can generate random number R as a coefficient of a linear term in the first polynomial function, that is, a=A, and b=R. An encoded first polynomial function can be expressed as y=Ax+R.

In this scenario example, the data-party device can substitute value x1 to the encoded first polynomial function to obtain function value y1 as fragment [A]₀ obtained after private data A is split, can substitute value x2 to the encoded first polynomial function to obtain function value y2 as another fragment [A]₁ obtained after private data A is split, and can substitute value x3 to the encoded first polynomial function to obtain function value y3 as another fragment [A]₂ obtained after private data A is split.

In this scenario example, the data-party device can send fragment [A]₀ to participant-party device P1, can send fragment [A]₁ to participant-party device P2, and can send fragment [A]₃ to participant-party device P3.

One or more embodiments of this specification further provide another data processing method for privacy protection. The method can be applied to the field of secure multi-party computation. The method can be performed by any of the plurality of participant-party devices.

Referring to FIG. 5, the method can include the following steps.

Step S21: Obtain fragments of a plurality of pieces of private data.

In some embodiments, the fragments of the private data can include function values of a first polynomial function. For a process of splitting the private data to obtain the fragments, reference can be made to the previous embodiment. Details are omitted here for simplicity.

In some embodiments, the participant-party device and a data-party device can be different computer devices. As such, a plurality of data-party devices can send the fragments of the plurality of pieces of private data to the participant-party device, and the participant-party device can receive the fragments of the plurality of pieces of private data, where each data-party device can send at least one fragment of the private data to the participant-party device. Alternatively, the participant-party device and a certain data-party device can be integrated as one computer device. As such, one or more data-party devices can send more or more fragments the private data to the participant-party device, and the participant-party device can receive the one or more fragments of the private data. In addition, the participant-party device can obtain a fragment of the private data locally.

Step S23: compute the fragments of the plurality pieces of private data by using a secret sharing algorithm to obtain fragments of target data.

In some embodiments, the target data can be a computation result obtained after secure multi-party computation is performed on private data of a plurality of data-party devices. For example, the target data can be user data, commodity data, transaction data, behavior data, a statistical indicator, a model parameter, a model prediction result, etc. For another example, the target data can further include text data, image data, audio data, etc. The target data can be a final result, or the target data can be an intermediate result. Therefore, computation can be further performed based on the fragments of the target data by continuing using the secret sharing algorithm.

In some embodiments, the secret sharing algorithm can include a secret sharing addition algorithm, and the target data can be the sum of the plurality of pieces of private data. In actual applications, the fragments of the plurality of pieces of private data can be added to obtain the fragments of the target data. Alternatively, the secret sharing algorithm can include a secret sharing multiplication algorithm, and the target data can be a product of the plurality of pieces of private data. In actual applications, the fragments of the plurality of pieces of private data can be multiplied to obtain the fragments of the target data.

In some embodiments, the fragments of the target data can be further sent to a recovery-party device, and therefore the recovery-party device recovers the target data based on the fragments of the target data.

According to the data processing method in the one or more embodiments of this specification, the fragments of the plurality of pieces of private data can be obtained, and the fragments of the plurality of pieces of private data can be computed by using the secret sharing algorithm. As such, the participant-party device can compute the fragments of the plurality of pieces of private data locally without a need for a third party, thereby improving computing efficiency of the secret sharing algorithm. Moreover, the computation process does not need to rely on auxiliary data satisfying specific conditions, and is applicable to secure multi-party computation that has a relatively large quantity of participant-party devices.

One or more embodiments of this specification further provide another data processing method for privacy protection. The method can be applied to the field of secure multi-party computation. The method can be performed by a recovery-party device.

Referring to FIG. 6, the method can include the following steps.

Step S31: Obtain a plurality of fragments of target data.

In some embodiments, for a process of generating the fragments of the target data, reference can be made to the previous embodiments. Details are omitted here for simplicity.

In some embodiments, the recovery-party device and a participant-party device can be different computer devices. As such, a plurality of participant-party devices can send the plurality of fragments of the target data to the recovery-party device, and the recovery-party device can receive the plurality of fragments of the target data, where each participant-party device can send one fragment of the target data to the recovery-party device. Alternatively, the recovery-party device and a certain participant-party device can be integrated as one computer device. As such, one or more participant-party devices can send one or more fragments of the target data to the recovery-party device, and the recovery-party device can receive the one or more fragments of the target data. In addition, the recovery-party device can further obtain a fragment of the target data locally.

Step S33: Compute a coefficient of a second polynomial function by using the plurality of fragments of the target data as a plurality of function values of the second polynomial function and based on the plurality of function values of the second polynomial function.

In some embodiments, a plurality of values corresponding to a plurality of participant-party devices can be obtained as a plurality of values of an independent variable, and the coefficient of the second polynomial function can be computed based on the plurality of values of the independent variable and the plurality of function values of the second polynomial function.

The data-party device, the participant-party device, or another computer device can send a value corresponding to the participant-party device to the recovery-party device, and the recovery-party device can receive the value corresponding to the participant-party device.

For each participant-party device, a value corresponding to the participant-party device and a fragment of the target data computed by the participant-party device can be understood as a sampling point of the second polynomial function. Therefore, a process of computing the coefficient of the second polynomial function can be understood as a process of converting a point representation method of the second polynomial function to a coefficient representation method. In actual applications, the coefficient of the second polynomial function can be computed by using a Lagrange interpolation method. Certainly, the coefficient of the second polynomial function can be computed in other methods. For example, the coefficient of the second polynomial function can be computed by using a system of equations.

Step S35: Recover the target data based on the coefficient of the second polynomial function.

In some embodiments, the target data is encoded to the coefficient of the second polynomial function.

A coefficient of one or more terms in the second polynomial function can be the target data. Which terms' coefficients are the target data depends on an encoding method that encodes private data to a coefficient of a first polynomial function. Specifically, a coefficient of one or more terms in the first polynomial function can be the private data. In this case, a coefficient of a corresponding term in the second polynomial function can be the target data, where the corresponding term can be a term with the same degree as the term in the first polynomial function.

For example, the private data can be determined as a constant term in the first polynomial function, and therefore a constant term in the second polynomial function can be the target data. For another example, the private data can be determined as a coefficient of a linear term in the first polynomial function, and therefore a coefficient of a linear term in the second polynomial function can be the target data.

In some embodiments, the constant term in the second polynomial function can be determined as the target data, or a coefficient of a term other than the constant term in the second polynomial function can be determined as the target data.

In some embodiments, all participant-party devices can send fragments of the target data to the recovery-party device, and the recovery-party device can recover the target data based on all fragments of the target data. Alternatively, some participant-party devices can send fragments of the target data to the recovery-party device, and the recovery-party device can recover the target data based on some fragments of the target data. For example, a degree of the second polynomial can be q, and a quantity of participant-party devices can be p, where p≥q+1. The (q+1) participant-party devices can send fragments of the target data to the recovery-party device, and the recovery-party device can recover the target data based on the (q+1) fragments of the target data. As such, only a part of the participant-party devices may be needed to participate in recovery of the target data.

According to the data processing method in the one or more embodiments of this specification, the plurality of fragments of the target data can be obtained, the coefficient of the second polynomial function can be computed by using the plurality of fragments of the target data as the plurality of function values of the second polynomial function and based on the plurality of function values of the second polynomial function, and the target data can be recovered based on the coefficient of the second polynomial function. As such, the target data is recovered by using the second polynomial function.

Secret sharing-based secure multi-party computation can be applied to various service scenarios, for example, a medical scenario, a model prediction scenario, etc. A scenario example of the embodiments of this specification is described below. It is worthwhile to note that the scenario example is merely intended to help understand the technical solutions in the embodiments of this specification, and constitutes no improper limitation on the technical solutions in the embodiments of this specification.

Restaurant pricing is related to customer reviews about food, decoration and services and traffic near the restaurant.

In this scenario example, institution A trains a price prediction model. The price prediction model can be used to determine food price in a restaurant. The price prediction model can be a linear regression model. For example, the price prediction model can be expressed as z=β₀+β₁x₁+β₂x₂+β₃x₃+β₄y, where β₀, β₁, β₂, β₃, and β₄ are model parameters of the price prediction model, x₁ represents an evaluation score of customers for food, x₂ represents an evaluation score of customers for decoration, x₃ represents an evaluation score of customers for a service, and y represents traffic data near a geographical location of a restaurant.

Institution B plans to open a new Italian restaurant at a target geographical location of a city. To price food, institution B organizes a sampling survey in the city, and obtains evaluation scores of customers for food, decoration, a service, etc.

Institution C holds traffic data near the target geographical location.

In this scenario example, institution B needs to price food. Because institution B does not have the price prediction model and the traffic data near the target geographical location, institution B can perform secret sharing-based secure multi-party computation with institution A and institution C. During secure multi-party computation, institution A cannot leak the price prediction model to institution B and institution C, institution B cannot leak the evaluation scores of the customers for the food, the decoration, the service, etc. to institution A and institution C, and institution C cannot leak the traffic data near the target geographical location to institution A and institution B.

In this scenario example, a data processing system can include a first device, a second device, and a third device.

The first device is set up by institution A, and the first device has functions of a data-party device and a participant-party device. The second device is set up by institution B, and the second device has functions of a data-party device, a participant-party device, and a recovery-party device. The third device is set up by institution C, and the third device has functions of a data-party device and a participant-party device.

For the model parameter βᵢ in the price prediction model, the first device can split the model parameter βᵢ by using the method in the embodiment corresponding to FIG. 4 to obtain three fragments [βᵢ]₀, [βᵢ]₁, and [βᵢ]₂ of the model parameter βᵢ. The first device can send fragment [βᵢ]₁ to the second device, and can send fragment [βᵢ]₂ to the third device. A value of i can be 0, 1, 2, 3, 4, etc.

For the evaluation score xᵢ of the customers, the second device can split the evaluation score xᵢ by using the method in the embodiment corresponding to FIG. 4 to obtain three fragments [xᵢ]₀, [xᵢ]₁, and [xᵢ]₂ of the evaluation score xᵢ. The second device can send fragment [xᵢ]₀ to the first device, and can send fragment [xᵢ]₂ to the third device. A value of i can be 1, 2, 3, etc.

For the traffic data y, the third device can split the traffic data y by using the method in the embodiment corresponding to FIG. 4 to obtain three fragments [y]₀, [y]₁, and [y]₂ of the traffic data y. The third device can send fragment [y]₀ to the first device, and can send fragment [y]₁ to the second device.

In this scenario example, the first device can compute [z]₀=[β₀]₀+[β₁]₀[x₁]₀+[β₂]₀[x₂]₀+[β₃]₀[x₃]₀+[β₄]₀[y]₀, the second device can compute [z]₁=[β₀]₁+[β₁]₁[x₁]₁+[β₂]₁[x₂]₁+[β₃]₁[x₃]₁+[β₄]₁[y]₃, and the third device can compute [z]₂=[β₀]₂+[β₁]₂[x₁]₂+[β₂]₂[x₂]₂+[β₃]₂[x₃]₂+[β₄]₂[y]₂, where [z]₀, [z]₁, and [z]₂ represent fragments of the food price in the restaurant.

In this scenario example, the first device can send fragment [z]₀ to the second device, the third device can send fragment [z]₂ to the second device, and the second device can recover the food price z in the restaurant based on fragments [z]₀, [z]₁, and [z]₂ by using the method in the embodiment corresponding to FIG. 6. As such, institution B obtains the food price in the restaurant by performing secret sharing-based secure multi-party computation with institution A and institution C. In addition, the data owned by institution A, institution B, and institution C is not leaked.

One or more embodiments of this specification further provide a data processing apparatus for privacy protection. The apparatus can be applied to the field of secure multi-party computation. The apparatus can be disposed in any of the plurality of data-party devices.

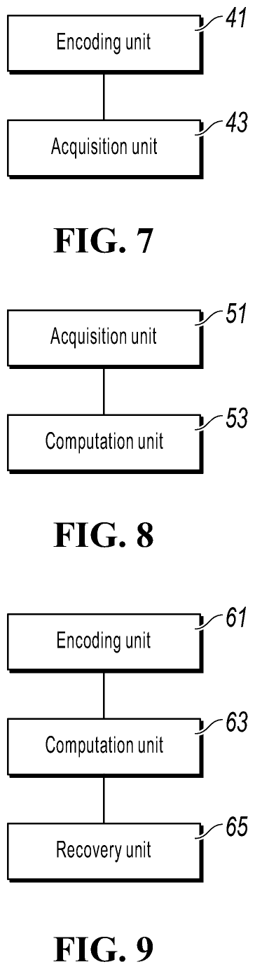

Referring to FIG. 7, the apparatus can include the following units: an encoding unit 41, configured to encode private data to a coefficient of a first polynomial function; and an acquisition unit 43, configured to obtain a plurality of function values of the first polynomial function as a plurality of fragments obtained after the private data is split, where the fragments of the private data are used for computation by using a secret sharing algorithm to obtain fragments of target data.

One or more embodiments of this specification further provide another data processing apparatus for privacy protection. The apparatus can be applied to the field of secure multi-party computation. The apparatus can be disposed in any of the plurality of participant-party devices.

Referring to FIG. 8, the apparatus can include the following units: an acquisition unit 51, configured to obtain fragments of a plurality of pieces of private data, where the fragments of the private data include function values of a first polynomial function, and the private data is encoded to a coefficient of the first polynomial function; and a computation unit 53, configured to compute the fragments of the plurality of pieces of private data by using a secret sharing algorithm to obtain fragments of target data.

One or more embodiments of this specification further provide another data processing apparatus for privacy protection. The apparatus can be applied to the field of secure multi-party computation. The apparatus can be disposed in a recovery-party device.

Referring to FIG. 9, the apparatus can include the following units: an acquisition unit 61, configured to obtain a plurality of fragments of target data, where the fragments of the target data are computed from fragments of private data, the fragments of the private data include function values of a first polynomial function, and the private data is encoded to a coefficient of the first polynomial function; a computation unit 63, configured to compute a coefficient of a second polynomial function by using the plurality of fragments of the target data as a plurality of function values of the second polynomial function and based on the plurality of function values of the second polynomial function, where the target data is encoded to the coefficient of the second polynomial function; and a recovery unit 65, configured to recover the target data based on the coefficient of the second polynomial function.

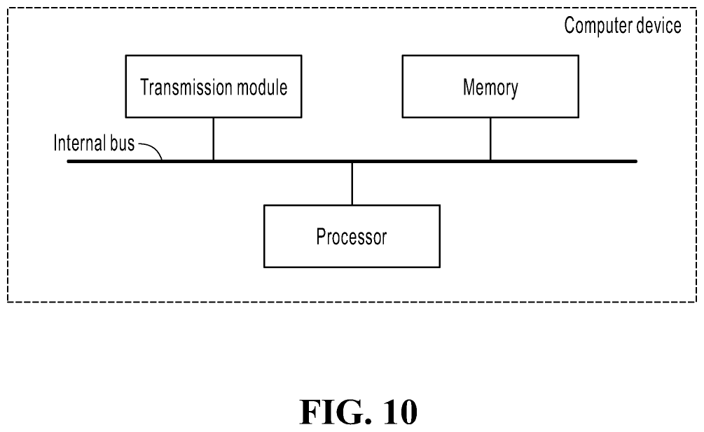

One or more embodiments of a computer device in this specification are described below. FIG. 10 is a schematic diagram illustrating a hardware structure of the computer device, according to the embodiments. As shown in FIG. 10, the computer device can include one or more processors (only one processor is shown in the figure), a memory, and a transmission module. Certainly, a person of ordinary skill in the art can understand that the hardware structure shown in FIG. 10 is merely an example and constitutes no limitation on the hardware structure of the computer device. In practice, the computer device can alternatively include more or fewer component units than those shown in FIG. 10, or have a configuration different from that shown in FIG. 10.

The memory can include a high-speed random access memory, or can further include a non-volatile memory, for example, one or more magnetic storage apparatuses, a flash memory, or another non-volatile solid state memory. Certainly, the memory can further include a remotely disposed network memory. The memory can be configured to store program instructions or modules of application software, for example, program instructions or modules in the embodiment corresponding to FIG. 4, FIG. 5, or FIG. 6 in this specification.

The processor can be implemented in any proper method. For example, the processor can be in a form of a microprocessor or processor and a computer-readable medium that stores computer-readable program code (for example, software or firmware) that can be executed by the (microprocessor) processor, a logic gate, a switch, an application specific integrated circuit (ASIC), a programmable logic controller, an embedded microcontroller, etc. The processor can read and execute the program instructions or modules in the memory.

The transmission module can be configured to transmit data through a network, for example, transmit data through networks such as the Internet, the intranet, a local area network, and a mobile communication network.

This specification further provides one or more embodiments of a computer storage medium. The computer storage medium includes but is not limited to a random access memory (RAM), a read-only memory (ROM), a cache, a hard disk drive (HDD), a memory card, etc. The computer storage medium stores computer program instructions. When the computer program instructions are executed, program instructions or modules in the embodiment corresponding FIG. 4, FIG. 5, or FIG. 6 in this specification are implemented.

It is worthwhile to note that the embodiments in this specification are all described in a progressive method. For same or similar parts of the embodiments, references can be made to the embodiments mutually. Each embodiment focuses on a difference from other embodiments. Particularly, the apparatus embodiments, the computer device embodiments, and the computer storage medium embodiments are basically similar to the method embodiments, and therefore are described briefly. For a related part, references can be made to some descriptions in the method embodiments. In addition, it can be understood that after reading this specification document, a person skilled in the art can figure out any combination of some or all of the embodiments enumerated in this specification without creative efforts. These combinations also fall within the scope disclosed and protected by this specification.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

The system, apparatus, module, or unit illustrated in the previous embodiments can be implemented by using a computer chip or an entity, or can be implemented by using a product having a certain function. A typical implementation device is a computer. Specifically, for example, the computer can be a personal computer, a laptop computer, a cellular phone, a camera phone, a smart phone, a personal digital assistant, a media player, a navigation device, an email device, a game console, a tablet computer, a wearable device, or a combination of any of these devices.

It can be seen from the descriptions of the implementations that a person skilled in the art can clearly understand that this specification can be implemented by using software plus a necessary general hardware platform. Based on such an understanding, the technical solutions in this specification essentially or the part contributing to the existing technology can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the methods described in the embodiments or in some parts of the embodiments of this specification.

This specification can be applied to many general-purpose or dedicated computer system environments or configurations, for example, a personal computer, a server computer, a handheld device or a portable device, a tablet device, a multi-processor system, a microprocessor-based system, a set-top box, a programmable consumption electronic device, a network PC, a minicomputer, a mainframe computer, and a distributed computing environment including any one of the previous systems or devices.

This specification can be described in the general context of computer-executable instructions executed by a computer, for example, a program module. Generally, the program module includes a routine, a program, an object, a component, a data structure, etc. that executes a specific task or implements a specific abstract data type. This specification can alternatively be practiced in distributed computing environments. In these distributed computing environments, tasks are performed by remote processing devices that are connected through a communications network. In the distributed computing environment, the program module can be located in both local and remote computer storage media including storage devices.

What is claimed is:

1. A computer-implemented method for privacy protection in secure multi-party computation, comprising:
encoding private data to a coefficient of a first polynomial function; and
obtaining a plurality of function values of the first polynomial function as a plurality of fragments obtained after the private data is split, wherein the fragments of the private data are used for computation by using a secret sharing algorithm to obtain fragments of target data.

2. The computer-implemented method of claim 1, wherein a coefficient of one or more terms in the first polynomial function is the private data.

3. The computer-implemented method of claim 1, wherein encoding private data to a coefficient of a first polynomial function, comprises:
determining the private data as a constant term in the first polynomial function.

4. The computer-implemented method of claim 3, comprising:
generating a random number as a coefficient of a term other than the constant term in the first polynomial function.

5. The computer-implemented method of claim 1, wherein obtaining a plurality of function values of the first polynomial function, comprises:
obtaining a plurality of values corresponding to a plurality of participant-party devices as a plurality of values of an independent variable.

6. The computer-implemented method of claim 5, comprising:
computing, based on the plurality of values of the independent variable, the plurality of function values of the first polynomial function.

7. The computer-implemented method of claim 1, comprising:
sending the plurality of fragments of the private data to a plurality of participant-party devices.

8. A non-transitory, computer-readable medium storing one or more instructions executable by a computer system to perform operations, comprising:
encoding private data to a coefficient of a first polynomial function; and
obtaining a plurality of function values of the first polynomial function as a plurality of fragments obtained after the private data is split, wherein the fragments of the private data are used for computation by using a secret sharing algorithm to obtain fragments of target data.

9. The non-transitory, computer-readable medium of claim 8, wherein a coefficient of one or more terms in the first polynomial function is the private data.

10. The non-transitory, computer-readable medium of claim 8, wherein encoding private data to a coefficient of a first polynomial function, comprises:
determining the private data as a constant term in the first polynomial function.

11. The non-transitory, computer-readable medium of claim 10, comprising:
generating a random number as a coefficient of a term other than the constant term in the first polynomial function.

12. The non-transitory, computer-readable medium of claim 8, wherein obtaining a plurality of function values of the first polynomial function, comprises:
obtaining a plurality of values corresponding to a plurality of participant-party devices as a plurality of values of an independent variable.

13. The non-transitory, computer-readable medium of claim 12, comprising:
computing, based on the plurality of values of the independent variable, the plurality of function values of the first polynomial function.

14. The non-transitory, computer-readable medium of claim 8, comprising:
sending the plurality of fragments of the private data to a plurality of participant-party devices.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
encoding private data to a coefficient of a first polynomial function; and
obtaining a plurality of function values of the first polynomial function as a plurality of fragments obtained after the private data is split, wherein the fragments of the private data are used for computation by using a secret sharing algorithm to obtain fragments of target data.

16. The computer-implemented system of claim 15, wherein a coefficient of one or more terms in the first polynomial function is the private data.

17. The computer-implemented system of claim 15, wherein encoding private data to a coefficient of a first polynomial function, comprises:
determining the private data as a constant term in the first polynomial function.

18. The computer-implemented system of claim 17, comprising:
generating a random number as a coefficient of a term other than the constant term in the first polynomial function.

19. The computer-implemented system of claim 15, wherein obtaining a plurality of function values of the first polynomial function, comprises:
obtaining a plurality of values corresponding to a plurality of participant-party devices as a plurality of values of an independent variable.

20. The computer-implemented system of claim 19, comprising:
computing, based on the plurality of values of the independent variable, the plurality of function values of the first polynomial function.
